(19) United States
(12) Patent Application Publication
(10) Pub. No.: US 2011/0320222 A1
(43) Pub. Date: Dec. 29, 2011

(54) Systems and methods for valuation of tangible items

(76) Inventors: James Fini, Natick, MA (US); Andrew Steele, Waltham, MA (US)

(21) Appl. No.: 12/659,539

(22) Filed: Mar. 11, 2010

Related U.S. Application Data
(60) Provisional application No. 61/209,763, filed on Mar. 11, 2009.

(51) Int. Cl. G06Q 40/00; G06Q 10/00

(52) U.S. Cl. 705/4; 705/306

(57) ABSTRACT

Computer-based tangible property item valuation systems and methods are disclosed. In one general aspect, these include business logic responsive to a machine-readable inventory listing comprising a plurality of machine-readable entries that each include at least a description of an item to be valued. A database stores valuation information for at least a plurality of the item entries, and logic is provided for assembling a valuation listing that includes valuation information retrieved from the database for at least a plurality of the item entries.

This application claims the benefit under 35 U.S.C. 119(e) of U.S. provisional application Ser. No. 61/209,763 filed Mar. 11, 2009, which is herein incorporated by reference.

### FIELD OF THE INVENTION

This invention relates to methods and apparatus for determining valuations for tangible items, such as personal property, for insurance purposes.

### BACKGROUND OF THE INVENTION

Computers have been used as a resource for determining valuations for tangible items in the insurance industry. They can allow more efficient processing of insurance claims, such as contents claims. But contents claims can potentially include any of an almost limitless number of items. Finding matches for all the items that might be found at the scene of a peril is therefore a daunting task.

### SUMMARY OF THE INVENTION

In one general aspect, the invention features a computer-based tangible property item valuation method that includes receiving a machine-readable inventory listing comprising a plurality of machine-readable entries that each include at least a description of an item to be valued. The method also includes the steps of retrieving digitally stored valuation information from a database for at least a plurality of the item entries, and assembling a valuation listing that includes valuation information retrieved from the database for at least a plurality of the item entries.

In preferred embodiments, the method can further include the steps of applying digitally stored business rules to the machine-readable entries in the claim and deriving machine-readable valuation information for at least one of the item entries in the inventory listing based on the business rules, with the step of assembling assembling a valuation listing that includes valuation information retrieved from the database and valuation information derived from at least one of the business rules. The business rules can include at least one business rule that is operative to detect descriptions of negotiable instruments and wherein the valuation information derived for this rule includes an amount for the negotiable instrument. The business rules can include at least one business rule that is operative to detect an exclusion identifier in the inventory listing, with this business rule being operative to prevent the step of retrieving from taking place for an entry that includes the exclusion identifier. The business rules can include at least one business rule that is operative to detect potential unit of measure errors. The business rules include at least one business rule that is operative to cause different valuation results to be included in the valuation listing in response to different service-level specifications. At least some of the business rules can prevent the step of retrieving from taking place, with the step of assembling assembling the valuation listing with valuation information resulting from the business rules for at least some of the item entries and with valuation information retrieved from the database for at least some other of the item entries. The valuation method can be an insurance valuation method, with the machine-readable inventory listing being an insurance claim inventory listing. The business rules can include at least one business rule that is operative to distinguish between different classes of users. The method can further including a step of providing a graphical outlining control that is responsive to user actuation to collapse item entries in the valuation listing into category headings.

In another general aspect, the invention features a computer-based tangible property item valuation method that includes receiving a machine-readable item entry of an inventory listing that includes at least a description of an item to be valued, receiving machine-readable background information pertaining to the inventory listing as a whole, and retrieving digitally stored valuation information from a database for the item entries in the listing using a search strategy that includes provisions for accessing both a description for that item entry and the background information for the inventory listing.

In preferred embodiments, the step of receiving background information can be responsive to machine-readable information about the nature of an insured peril that affected the items in the inventory listing. The step of receiving background information can be responsive to machine-readable information about the type of insurance coverage that covered the items in the inventory listing. The step of receiving background information can be responsive to machine-readable demographic information about a policy holder for an insurance policy that covered the items in the inventory listing. The step of receiving background information can be responsive to machine-readable demographic information about an owner of the items in the inventory listing. The step of retrieving can employ a search strategy that is operative to access the background information in defining at least one of a query formulation, a search type selection, a result filtering specification, and a certainty determination specification.

In a further general aspect, the invention features a computer-based tangible property item valuation method that includes receiving a machine-readable inventory listing comprising a plurality of machine-readable entries that each include at least a description of an item to be valued, extracting information from one of the item entries, extracting information from one or more further ones of the item entries, and retrieving digitally stored valuation information from a database of items for a least the one of the item entries both based on the description for that item entry and based on information about the further item entries. The information about the other item entries can be based on retrieved valuation information for the other entries.

In another general aspect, the invention features a computer-based tangible property item valuation method that includes receiving a machine-readable inventory listing comprising a plurality of machine-readable entries that each include at least a description of an item to be valued, applying an automatic computer-based reserve estimating process to the inventory listing, electronically communicating a result of the computer-based estimating process to a user, and retrieving digitally stored valuation information from a database for item entries in the inventory listing, wherein at least part of the step of retrieving takes place after the step of communicating.

In a further general aspect, the invention features a computer-based tangible property item valuation method that includes receiving a machine-readable item record that includes at least a natural language description of an item to be valued, wherein the natural language description includes a plurality of words, detecting linguistic features in the natural language description in the machine readable item record, applying a set of item information extraction rules to the linguistic features to create a distilled query, and retrieving digitally stored valuation information from a database for the machine-readable item record using the distilled query.

In preferred embodiments, the step of detecting can detect a first noun-phrase in the natural language description and the step of applying extracts the first noun-phrase and adds it to the distilled query. The step of detecting can detect a first noun in a first noun-phrase and the step of applying extracts the first noun and adds it to the distilled query. The step of applying a set of information extraction rules can exclude all terms to the right of the first noun. The step of adding one or more words to the left of the first noun can be based on the relevance testing of the one or more words. The method can further include a step of determining whether the description was entered in a deliberately reversed inventory-specific format, with the step of detecting linguistic features being responsive to a result of the step of determining. The step of detecting can detect terms with low information content, with the step of applying a set of information extraction rules excluding the detected low-information content terms from the distilled query.

In another general aspect, the invention features a computer-based tangible property item valuation method includes receiving a machine-readable item record that includes at least a description of an item to be valued, retrieving digitally stored valuation information from a database for the item entries, deriving a confidence measure for the valuation information for each of the entries, and communicating both the retrieved valuation information and the confidence measure to a user for at least one of the item entries.

In preferred embodiments, the method can further include a step of presenting at least one graphical cue to identify item entries for which the step of deriving has returned a confidence value that is below a predetermined threshold. The method can further include a step of assembling a valuation listing and wherein the step of communicating communicates the retrieved valuation information and the confidence measure through the valuation listing. The valuation listing and the inventory listing can be part of a combined listing. The method can further include a step of presenting at least one graphical cue to identify item entries for which the step of deriving has returned a confidence value that is below a predetermined threshold. The method can further include a step of providing a graphical outlining control that is responsive to user actuation to collapse item entries in the valuation listing into category headings. The step of retrieving can retrieve the digitally stored valuation information from a relational database that includes structured and unstructured content.

In a further general aspect, the invention features a computer-based tangible property item valuation method that includes receiving from a first user a first machine-readable item record that includes at least a description of an item to be valued, applying a first set of rules to the first machine-readable item record from the first user, retrieving digitally stored valuation information from a database for the first machine-readable item record, presenting to the first user at least some of the retrieved digitally stored valuation information for the first machine-readable item record, wherein content of the digitally stored valuation information presented to the first user is responsive to the step of applying a first set of rules, receiving from a second user a second machine-readable item record that includes at least a description of an item to be valued, applying a second set of rules to the second machine-readable item record from the second user, wherein the second set of rules is different from the first set of rules, retrieving digitally stored valuation information from a database for the second machine-readable item record, and presenting to the second user at least some of the retrieved digitally stored valuation information for the second machine-readable item record, wherein content of the digitally stored valuation information presented to the first user is responsive to the step of applying a second set of rules.

In preferred embodiments, the step of applying the first set of rules and the step of applying the second set of rules can both apply group-level access rules. The step of applying the first set of rules can be based on a profile for the first user and the step of applying the second set of rules is based on a profile for the second user.

In another general aspect, the invention features a computer-based tangible property item valuation system based on stored instructions operative to run on a processor that includes business logic responsive to a machine-readable inventory listing comprising a plurality of machine-readable entries that each include at least a description of an item to be valued, a database for storing valuation information for at least a plurality of the item entries, and logic for assembling a valuation listing that includes valuation information retrieved from the database for at least a plurality of the item entries.

In preferred embodiments, the system can further include storage for history information and wherein the business logic is responsive to the history information storage, The system can further include storage for user profiles and wherein the business logic is responsive to the user profile storage. The system can further include storage for claim and policy data information and wherein the business logic is responsive to the claim and policy data storage. The system can further include a claim estimator responsive to the stored valuation information in the database. The system can further include a claim output interface responsive to the stored valuation information in the database. The system can further include a graphical outlining control that is responsive to user actuation to collapse item entries in the valuation listing into category headings. The system can further include logic for detecting linguistic features in a natural language description in the machine readable item record. The system can further include logic for deriving a confidence measure for the valuation information for each of the entries.

In a further general aspect, the invention features a computer-based tangible property item valuation system based on stored instructions operative to run on a processor that includes logic for receiving a machine-readable inventory listing comprising a plurality of machine-readable entries that each include at least a description of an item to be valued, logic for retrieving digitally stored valuation information from a database for at least a plurality of the item entries, and logic for assembling a valuation listing that includes valuation information retrieved from the database for at least a plurality of the item entries.

In preferred embodiments, the valuation system can be an insurance valuation system, with the machine-readable inventory listing being an insurance claim inventory listing. The business logic can implement at least one business rule that is operative to distinguish between different classes of users.
In another general aspect, the invention features a computer-based tangible property item valuation system that includes means for receiving a machine-readable inventory listing comprising a plurality of machine-readable entries that each include at least a description of an item to be valued, means for retrieving digitally stored valuation information from database means for at least a plurality of the item entries, and means for assembling a valuation listing that includes valuation information retrieved from the database for at least a plurality of the item entries.

### BRIEF DESCRIPTION OF-THE-DRAWING FIG. 1 is a block diagram of an illustrative computer-based tangible item valuation system according to the invention;

FIG. 2 is an illustrative screen view for the system of FIG. 1; and

FIG. 3 is an annotated illustrative product description for the system of FIG. 1.

### DETAILED DESCRIPTION OF AN ILLUSTRATIVE EMBODIMENT

Referring to FIG. 1, an illustrative computer-based tangible item valuation system 10 according to the invention can include Extract, Transform, and Load (ETL) logic 14 that retrieves item listing data from different vendors 12 and stores them in a database 16. These data can be retrieved from a variety of different types of sources, such as retailer websites, overstock vendors, auction websites, FTP sites, and uploaded spreadsheets. The database can be an enterprise-grade relational database that allows the system to store and index large numbers of product descriptions extracted from vendor sources.

The system 10 can also include a search engine 18 designed to search the database 16. The search engine retrieves records from the database based on a search query using one or more search methods. It can include an off-the-shelf configurable search engine or it can be built specifically for the valuation system.

The system 10 can include business and access rule logic 22, which can apply business rules to queries received from users 30, 32 to resolve some types of queries and to develop search strategies for others. The business rules can help to improve performance by flagging or correcting errors, keeping certain simple types of queries from being sent to the database, and by distilling queries to improve retrieval and/or confidence levels in results. Some examples of rules that process simple line items can include rules that detect references to cash and other negotiable instruments and rules that detect exclusion identifiers, such as “illegible entry”-type annotations. Other types of rules can flag or detect unit of measure errors, such as references to a “package” of items or a “dozen” items. Some types of business rules can also be applied to the results of a search.

The business and access rule logic 22 can service requests from a variety of different types of users. These can include; for example, employees of a valuation service (native users 30), insurance company employees, assessors, and policyholders (third-party users 32). These users generally interact with the system through networked computers that can be remote from the database.

The access rule logic can allow different users and different classes of users to interact with the system differently. Household policyholders, for example, can be prevented from accessing records in the database 16 that are derived from wholesale vendors. And larger entities that tend to deal in large volumes may receive discounted price quotes that smaller entities cannot access.

The access rule logic can also allow users to customize the way that they access the system using personal profiles 42. Assessors who work in a limited geographic area, for example, might want to favor locally popular vendors. And advanced users might also want to select a particular type of search strategy, such as a specific query distillation method.

This multi-tiered, customized approach can result in highly efficient and streamlined operations. The revenue associated with large numbers of users can be allocated to assembling a more extensive collection of vendor data and to more in-depth curation of the database than might otherwise be possible for a series of smaller systems. Managing a single database can also help to keep results provided by a single organization consistent, and can simplify operations by reducing work that might otherwise be duplicated across different systems.

The business rules can provide for improved searches by taking into consideration claim and policy data 44. These can include demographic information for the policy holder, the nature of the peril, as well as policy riders and exclusions.

Demographic information for the policyholder can help to target searching in a variety of ways. Zip codes can be used to account for regional vendor preferences, for example. They may also be used to match the types of goods to those most likely to be purchased in a particular neighborhood.

Policy limitations and the nature the peril can affect searching in a variety of ways. Line items for a policy that permits replacement with used goods, for example, can be searched in used item vendor records, while a search for a policy that does not permit replacement would exclude records for these vendors. And household and commercial policies can be searched in very different ways.

The system 10 can also use history information 42 to improve matching. This history information can be derived from user feedback as item lists are processed. In one embodiment, users can interact with controls to indicate that a match is poor and then select a better one manually, as they review a claim's inventory list. Information from this manual selection can be fed back to the system to prevent a similar query from failing in the same way.

The system 10 can also use a cache 20 to improve system performance. The cache is preferably managed at the business rule level, where frequently occurring queries are identified (e.g., the 1000 most commonly access queries). When a cached, frequently occurring query is detected, the corresponding target can be retrieved from the cache with a high level of confidence and without resort to the database.

Systems according to the invention can also provide for multi-line claim input in which the user provides the system with a machine-readable inventory list file, such as a spreadsheet, a tagged data file (e.g., an XML file), or a delimited text file. Instead of entering line items one-by-one and waiting for each of these to be processed, therefore, the user can simply wait for a whole inventory listing to be processed while he or she works on something else. The system can then alert the user when the processing has finished.

The system 10 can employ reserve/completion estimation logic 26 to provide reserve and completion estimates to the user at the onset of claim processing, or shortly thereafter. Business rules can process the list quickly to determine an estimated reserve amount for the claim, and the system can communicate the reserve to the insurer. As is often required by law, this reserve amount can be set aside immediately in view of satisfying the claim. The system can also provide an estimated completion time, which can be communicated to the user of the system. The estimates can be communicated to the user in a variety of ways, such as in an on-screen display area or by e-mail. The estimates may also be communicated to other areas, such as to a computer system run by a reserve processing group.

Systems according to the invention can also improve their search capabilities based on other line items and/or matches for the other line items. If an item entry for an inventory list lists a “rod,” for example, it may be difficult to determine what kind of rod it is. But if the line item for this rod is in close proximity to, or at least in the same inventory listing as, line items for a series of window treatments, such as valences or curtains, it may become much more likely in that it is a curtain rod.

The system 10 can provide confidence levels in addition to its matches. These provide the user with an indication of the level of confidence in particular search results. Confidence levels can be determined from a scan of a result set retrieved from the database 16, from the quality of results from similar searches for other claims, or through any other suitable metric. Providing confidence levels allows the user to focus on the most uncertain items while he or she reviews the results of a processed claim inventory.

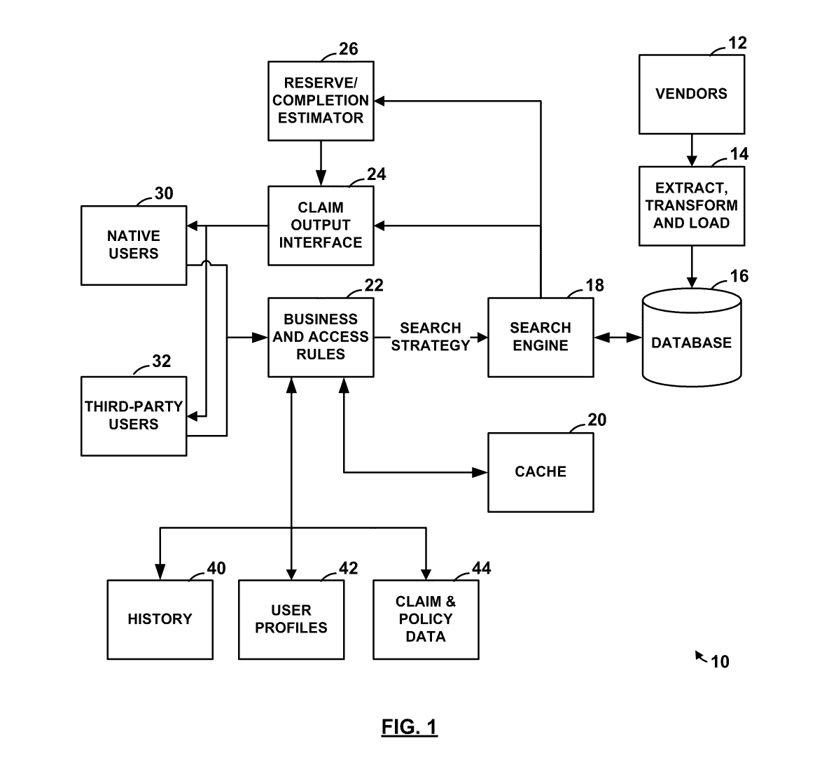

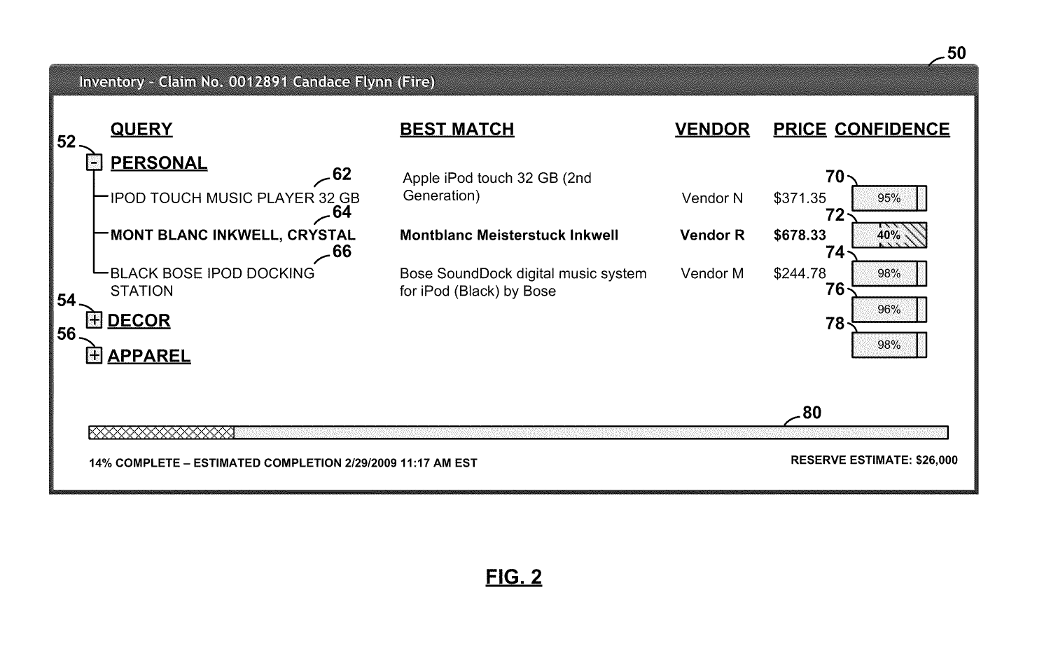

Referring to FIG. 2, a claim report window 50 can employ a collapsible outline format. This format allows long claims to be collapsed in one or more category levels, such as apparel, electronics, housewares, and the like. Users can then use outline controls 52, 54, 56 to expand or collapse the categories to see individual line items 62, 64, 66.

The collapsible outline format can provide several additional advantages. It can provide confidence level indicators 70, 72, 74, 76, 78 for each category, for example. It can also provide progress monitoring indications 80 for each category. And it can provide an automatic expansion of categories where there are poor matches as determined by the system. This selective automatic expansion approach can allow a user to receive the claim listing and immediately see the few items that need manual attention; while hiding the items that appear to be well-matched. The result can be faster review and procesing of results performed by claim review personnel. It may even be possible to allow users to work with inventory lists as they are being processed, with the users seeing only those line items that need attention. Overall, collapsible outlining can provide a richer, friendlier user experience, and can reduce or eliminate the tedious process of scrolling through long lists of well-matched items to find a few poorly matched ones buried in their midst.

The ETL logic 14 receives vendor data and can apply conventional ETL techniques to them, such as filtering, column selection, and data cleansing. The ETL logic can also perform product-optimized description-processing. This processing analyzes and distills product descriptions for improved confidence and/or retrieval.

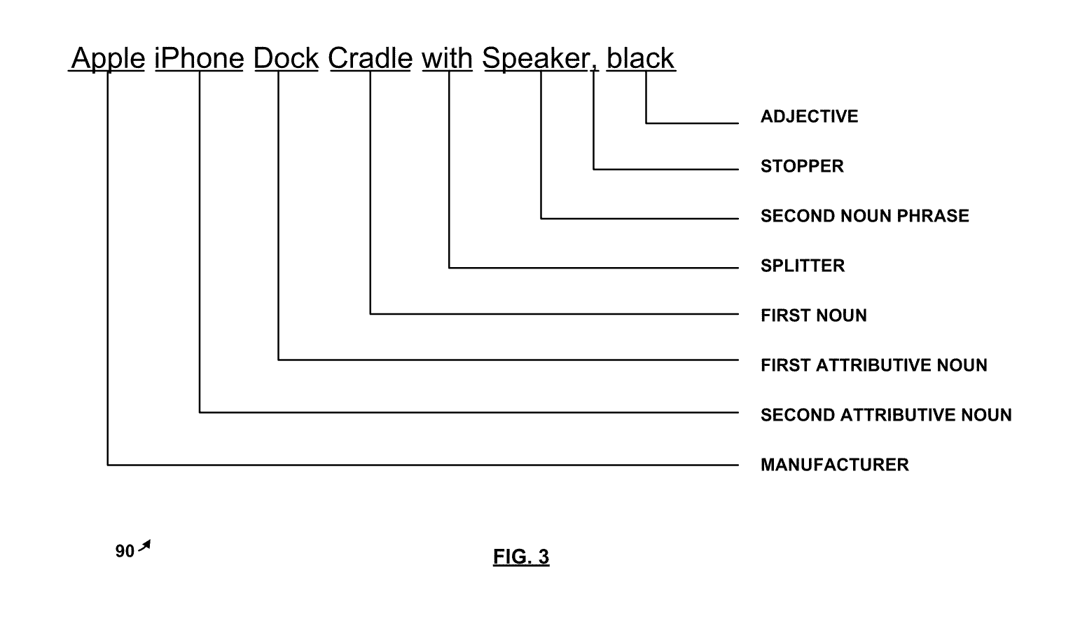

Referring to FIG. 3, an illustrative description includes a natural language description 90 of an item. To process this description, the ETL logic detects the following types of syntactic elements:

| ELEMENT | EXAMPLE (Regex format) |
|---|---|
| Stoppers | ,“, “-”, “in”, “by”, “from”, “set in”, |
| | “framed in”, “framing”, “for” |
| Splitters | “(?:\hat{ }\|)and”, “(?:\hat{ }\|)with”, “(?:\hat{ }\|)w/” |
| Useless | “\\(.+\\)” |
| Units | “MB”, “MB/MO”, “GB”, “GB/GO”, |
| | “GHz”, “MHz”, “kHz”, “Hz”, “oz\\.?”, |
| | “foot”, “ft\\.?”, “inch”, “in\\.?”, “cans?”, |
| | “pack”, “minutes?”, “seconds?”, |
| | “megapixel”, “MP”, “x\\W?speed”, |
| | “x\\W+\\d+\\W?x\\W?speed”, “W” |
| Separators | “/”, “&”, “” |
| Bad words | “\\D*\\d{2,}\\D*” |

These elements allow the ETL logic to create a distilled description that can help to improve retrieval from the database and maximize the confidence of matches. The following method has been found to use these elements in a way that achieves improved matching on several test data sets populated with product data derived from different internet retail sites. The method begins by locating the first stopper in the description and then discarding the rest of the query, with the objective of finding the leftmost noun-phrase. In the example shown in FIG. 3, therefore, the word “black” would be discarded. The description is also stripped of “useless” terms, such as parentheticals, units, and “bad words” (e.g., words with too many digits in them).

Any splitters that exist in the remaining portion of the description are then detected. These splitters can be used to divide up the remaining portion of the description. Usually, the leftmost part is the most important, but all of the split-up parts can also be indexed separately.

Each remaining description portion is then processed from the right to create the shortest description that meets a predetermined test. In one embodiment, this is achieved by beginning with the rightmost word in the description, which is usually a noun such as “cradle,” and testing it against an existing product database. If all of the matches then fall in a single product category, such as “electronics,” the noun alone can be indexed in the database. If the matches fall in more than one category, one word is added to the left of the noun (usually an attribute of the noun such as “dock”). If all the matches fall in a single product category, the two-word description can be indexed in the beta database. If all the matches do not fall in a single product category, words are added to description from the left until the test is satisfied, or there are no more words to add.

This distillation method is also applied to queries received from system users. Tests of this process tend to show that it produces better matches, probably at least in part because extraneous information that can cause false positive results is removed from both the query and the database.

The distillation process can be varied and adjusted in many ways, and the best method depends on a variety of factors, such as the nature of the insured base, regional linguistic particularities, and the description styles used by vendors selected to populate the database. In established industrial settings, for example, part numbers may provide unique and highly reliable replacement information. In newer consumer-oriented industries, however, part numbers may be obsolete after a single season. The system might therefore place a different level of emphasis on numerical information when processing different types of claims.

The search strategies for a particular item can also be adjusted in other ways than by distilling the query. The type of search can be varied (e.g., statistical, or Boolean, or a natural language search). The way in which results are sorted or prioritized can also be adjusted (e.g., certain categories can be favored). And the confidence determination can be adjusted depending on the context of the claim.

The system described above can be implemented in connection with a special-purpose software program running on a general-purpose computer platform, but it could also be implemented in whole or in part using special-purpose hardware. And while the system can be broken into the series of modules and steps shown in the various figures for illustration purposes, one of ordinary skill in the art would recognize that it is also possible to combine them and/or split them differently to achieve a different breakdown. Each of the steps can therefore be performed by corresponding logic embodied in software or hardware.

Interaction with the system can take place through a standard web browser that presents the user with interactive pages such as the one shown in FIG. 2. The system can also use other methods of interaction, such as ones based on tagged document formats, e-mail protocols, or custom user interface elements or protocols.

The system described above can also be used in connection with the concepts described in U.S. application Ser. Nos. 12/380,402, 2010-0049552, and 2010-0030585 which are all herein incorporated by reference.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A computer-based tangible property item valuation method, comprising:
receiving a machine-readable inventory listing comprising a plurality of machine-readable entries that each include at least a description of an item to be valued,
retrieving digitally stored valuation information from a database for at least a plurality of the item entries, and
assembling a valuation listing that includes valuation information, retrieved from the database for at least a plurality of the item entries.

2. The method of claim 1 further including the steps of applying digitally stored business rules to the machine-readable entries in the claim and deriving machine-readable valuation information for at least one of the item entries in the inventory listing based on the business rules, and wherein the step of assembling assembles a valuation listing that includes valuation information retrieved from the database and valuation information derived from at least one of the business rules.

3. The method of claim 1 wherein the business rules include at least one business rule that is operative to detect descriptions of negotiable instruments and wherein the valuation information derived for this rule includes an amount for the negotiable instrument.

4. The method of claim 1 wherein the business rules include at least one business rule that is operative to detect an exclusion identifier in the inventory listing and wherein this business rule is operative to prevent the step of retrieving from taking place for an entry that includes the exclusion identifier.

5. The method of claim 1 wherein the business rules include at least one business rule that is operative to detect potential unit of measure errors.

6. The method of claim 1 wherein the business rules include at least one business rule that is operative to cause different valuation results to be included in the valuation listing in response to different service-level specifications.

7. The method of claim 1 wherein at least some of the business rules prevent the step of retrieving from taking place and wherein the step of assembling assembles the valuation listing with valuation information resulting from the business rules for at least some of the item entries and with valuation information retrieved from the database for at least some other of the item entries.

8. The method of claim 1 wherein the valuation method is an insurance valuation method and wherein the machine-readable inventory listing is an insurance claim inventory listing.

9. The method of claim 1 wherein the business rules include at least one business rule that is operative to distinguish between different classes of users.

10. The method of claim 1 further including a step of providing a graphical outlining control that is responsive to user actuation to collapse item entries in the valuation listing into category headings.

11. A computer-based tangible property item valuation method, comprising:
receiving a machine-readable item entry of an inventory listing that includes at least a description of an item to be valued,
receiving machine-readable background information pertaining to the inventory listing as a whole, and
retrieving digitally stored valuation information from a database for the item entries in the listing using a search strategy that includes provisions for accessing both a description for that item entry and the background information for the inventory listing.

12. The method of claim 11 wherein the step of receiving background information is responsive to machine-readable information about the nature of an insured peril that affected the items in the inventory listing.

13. The method of claim 11 wherein the step of receiving background information is responsive to machine-readable information about the type of insurance coverage that covered the items in the inventory listing.

14. The method of claim 11 wherein the step of receiving background information is responsive to machine-readable demographic information about a policy holder for an insurance policy that covered the items in the inventory listing.

15. The method of claim 11 wherein the step of receiving background information is responsive to machine-readable demographic information about an owner of the items in the inventory listing.

16. The method of claim 11 wherein the step of retrieving employs a search strategy that is operative to access the background information in defining at least one of a query formulation, a search type selection, a result filtering specification, and a certainty determination specification.

17. A computer-based tangible property item valuation method, comprising:
receiving a machine-readable inventory listing comprising a plurality of machine-readable entries that each include at least a description of an item to be valued,
extracting information from one of the item entries,
extracting information from one or more further ones of the item entries, and
retrieving digitally stored valuation information from a database of items for a least the one of the item entries both based on the description for that item entry and based on information about the further item entries.

18. The method of claim 17 wherein the information about the other item entries is based on retrieved valuation information for the other entries.

19. A computer-based tangible property item valuation method, comprising:
receiving a machine-readable inventory listing comprising a plurality of machine-readable entries that each include at least a description of an item to be valued,
applying an automatic computer-based reserve estimating process to the inventory listing,
electronically communicating a result of the computer-based estimating process to a user, and
retrieving digitally stored valuation information from a database for item entries in the inventory listing, wherein at least part of the step of retrieving takes place after the step of communicating.

20. A computer-based tangible property item valuation method, comprising:
receiving a machine-readable item record that includes at least a natural language description of an item to be valued, wherein the natural language description includes a plurality of words,
detecting linguistic features in the natural language description in the machine readable item record,
applying a set of item information extraction rules to the linguistic features to create a distilled query, and
retrieving digitally stored valuation information from a database for the machine-readable item record using the distilled query.

21. The method of claim 20 wherein the step of detecting detects a first noun-phrase in the natural language description and the step of applying extracts the first noun-phrase and adds it to the distilled query.

22. The method of claim 20 wherein the step of detecting detects a first noun in a first noun-phrase and the step of applying extracts the first noun and adds it to the distilled query.

23. The method of claim 21 wherein the step of applying a set of information extraction rules excludes all terms to the right of the first noun.

24. The method of claim 22 further including the step of adding one or more words to the left of the first noun based on the relevance testing of the one or more words.

25. The method of claim 20 further including a step of determining whether the description was entered in a deliberately reversed inventory-specific format, and wherein the step of detecting linguistic features is responsive to a result of the step of determining.

26. The method of claim 20 wherein the step of detecting detects terms with low information content and wherein the step of applying a set of information extraction rules excludes the detected low-information content terms from the distilled query.

27. A computer-based tangible property item valuation method, comprising:
receiving a machine-readable item record that includes at least a description of an item to be valued,
retrieving digitally stored valuation information from a database for the item entries,
deriving a confidence measure for the valuation information for each of the entries, and
communicating both the retrieved valuation information and the confidence measure to a user for at least one of the item entries.

28. The method of claim 27 further including a step of presenting at least one graphical cue to identify item entries for which the step of deriving has returned a confidence value that is below a predetermined threshold.

29. The method of claim 27 further including a step of assembling a valuation listing and wherein the step of communicating communicates the retrieved valuation information and the confidence measure through the valuation listing.

30. The method of claim 29 wherein the valuation listing and the inventory listing are part of a combined listing.

31. The method of claim 29 further including a step of presenting at least one graphical cue to identify item entries for which the step of deriving has returned a confidence value that is below a predetermined threshold.

32. The method of claim 29 further including a step of providing a graphical outlining control that is responsive to user actuation to collapse item entries in the valuation listing into category headings.

33. The method of claim 27 wherein the step of retrieving retrieves the digitally stored valuation information from a relational database that includes structured and unstructured content.

34. A computer-based tangible property item valuation method, comprising:
receiving from a first user a first machine-readable item record that includes at least a description of an item to be valued,
applying a first set of rules to the first machine-readable item record from the first user,
retrieving digitally stored valuation information from a database for the first machine-readable item record,
presenting to the first user at least some of the retrieved digitally stored valuation information for the first machine-readable item record, wherein content of the digitally stored valuation information presented to the first user is responsive to the step of applying a first set of rules,
receiving from a second user a second machine-readable item record that includes at least a description of an item to be valued,
applying a second set of rules to the second machine-readable item record from the second user, wherein the second set of rules is different from the first set of rules,
retrieving digitally stored valuation information from a database for the second machine-readable item record, and
presenting to the second user at least some of the retrieved digitally stored valuation information for the second machine-readable item record, wherein content of the digitally stored valuation information presented to the first user is responsive to the step of applying a second set of rules.

35. The method of claim 34 wherein the step of applying the first set of rules and the step of applying the second set of rules both apply group-level access rules.

36. The method of claim 34 wherein the step of applying the first set of rules is based on a profile for the first user and the step of applying the second set of rules is based on a profile for the second user.

37. A computer-based tangible property item valuation system based on stored instructions operative to run on a processor, comprising:
business logic responsive to a machine-readable inventory listing comprising a plurality of machine-readable entries that each include at least a description of an item to be valued,
a database for storing valuation information for at least a plurality of the item entries, and
logic for assembling a valuation listing that includes valuation information retrieved from the database for at least a plurality of the item entries.

38. The system of claim 37 further including storage for history information and wherein the business logic is responsive to the history information storage.

39. The system of claim 37 further including storage for user profiles and wherein the business logic is responsive to the user profile storage.

40. The system of claim 37 further including storage for claim and policy data information and wherein the business logic is responsive to the claim and policy data storage.

41. The system of claim 37 further including a claim estimator responsive to the stored valuation information in the database.

42. The system of claim 37 further including a claim output interface responsive to the stored valuation information in the database.

43. The system of claim 37 further including a graphical outlining control that is responsive to user actuation to collapse item entries in the valuation listing into category headings.

44. The system of claim 37 further including logic for detecting linguistic features in a natural language description in the machine readable item record.

45. The system of claim 37 further including logic for deriving a confidence measure for the valuation information for each of the entries.

46. A computer-based tangible property item valuation system based on stored instructions operative to run on a processor, comprising:
logic for receiving a machine-readable inventory listing comprising a plurality of machine-readable entries that each include at least a description of an item to be valued,
logic for retrieving digitally stored valuation information from a database for at least a plurality of the item entries, and
logic for assembling a valuation listing that includes valuation information retrieved from the database for at least a plurality of the item entries.

47. The system of claim 46 wherein the valuation system is an insurance valuation system and wherein the machine-readable inventory listing is an insurance claim inventory listing.

48. The system of claim 46 wherein the business logic implements at least one business rule that is operative to distinguish between different classes of users.

49. A computer-based tangible property item valuation system, comprising:
means for receiving a machine-readable inventory listing comprising a plurality of machine-readable entries that each include at least a description of an item to be valued,
means for retrieving digitally stored valuation information from database means for at least a plurality of the item entries, and
means for assembling a valuation listing that includes valuation information retrieved from the database for at least a plurality of the item entries.
